(19) United States
(12) Patent Application Publication
(10) Pub. No.: US 2021/0042859 A1
(43) Pub. Date: Feb. 11, 2021

(54) FACILITY USAGE ASSISTANCE METHOD, FACILITY USAGE ASSISTANCE DEVICE, AND USER TERMINAL DEVICE

(71) Applicant: PANASONIC INTELLECTUAL PROPERTY MANAGEMENT CO., LTD., Osaka (JP)

(72) Inventor: Kazuhiko IWAI, Kanagawa (JP)

(73) Assignee: PANASONIC INTELLECTUAL PROPERTY MANAGEMENT CO., LTD., Osaka (JP)

(21) Appl. No.: 16/070,380

(22) PCT Filed: Nov. 11, 2016
(86) PCT No.: PCT/JP2016/004869

§ 371 Date: Jul. 16, 2018

(30) Foreign Application Priority Data
Jan. 26, 2016 (JP) 2016-012533

(51) Int. Cl. G06Q 50/10; G06Q 10/06; G06Q 10/04

(52) U.S. Cl. CPC G06Q 50/10; G06Q 10/04; G06Q 10/06

(57) ABSTRACT

To allow a user to determine a destination easily and quickly with intuitive determination when the user uses a facility. In a communicator of a server device, congestion detection information for each usage area, detected from a captured image obtained by a camera capturing the image of the usage area is acquired, in a required time acquisitor and a congestion presentation information acquisitor, a time required for the user to use the usage area is calculated for each usage area and congestion presentation information representing a congestion level of the usage area is acquired for each usage area based on the congestion presentation information, and in a browsing screen generator, a browsing screen including the required time and the congestion presentation information for each of a plurality of the usage areas where the use of the user is assumed is generated.

### TECHNICAL FIELD

The present disclosure relates to a facility usage assistance method, a facility usage assistance device, and a user terminal device that provide a facility user with information on a congestion state of a usage area by an information processing device to assist the facility usage of the user.

### BACKGROUND ART

By providing a user using facilities such as an airport with information on a state in the facilities so as to assist the facility usage of the user, it is possible to enhance user convenience and improve customer satisfaction.

As a technology of assisting a facility usage of a user by providing such information, in the related art, a technology of acquiring information on a congestion state (the number of vacant seats and the number of waiting people) of each store from an image captured by a camera installed in each store and acquiring a current position and demand of the user to select an appropriate store for the user from a plurality of stores and represent the selected store to the user is disclosed (refer to PTL 1).

A technology of acquiring a waiting time of a store where a user has visited, and a waiting time of a neighboring store and a moving time to the neighboring store to guide the user to use the neighboring store in a case where the sum of the waiting time of the neighboring store and the moving time is shorter than the waiting time of the store where the user has visited is disclosed (refer to PTL 2).

### CITATION LIST

### Patent Literature

PTL 1: Japanese Patent Unexamined Publication No. 2011-008454

PTL 2: Japanese Patent Unexamined Publication No. 2010-044575

### SUMMARY OF THE INVENTION

According to the present disclosure, there is provided a facility usage assistance method that provides a user using a usage area in a facility with information on a congestion state of the usage area by an information processing device to assist a facility usage of the user. The facility usage assistance method, by the information processing device, includes acquiring congestion detection information for each usage area, detected from a captured image obtained by a camera capturing the image of the usage area; calculating a time required for the user to use the usage area for each of the usage areas and acquiring congestion presentation information representing a congestion level of the usage area for each usage area, based on the congestion detection information; and generating a browsing screen including the required time and the congestion presentation information for each of a plurality of the usage areas where the use of the user is assumed.

According to the present disclosure, there is provided a facility usage assistance device that provides a user using a usage area in a facility with information on a congestion state of the usage areas by an information processing device to assist a facility usage of the user. The facility usage assistance device includes a communicator that performs communication with a camera that captures an image of the usage area and a user terminal device; and a controller that generates a browsing screen to be displayed on the user terminal device. The communicator receives congestion detection information for each usage area, detected from the image captured from the camera, and the controller calculates a time required for the user to use the usage area for each of the usage areas and acquires congestion presentation information representing a congestion level of the usage area for each usage area, based on the congestion detection information, and generates a browsing screen including the required time and the congestion presentation information for each of a plurality of the usage areas where the use of the user is assumed.

According to the present disclosure, there is provided a user terminal device that presents information on a congestion state of a usage area in a facility to a user using the usage area. The user terminal device includes a communicator that performs communication with a facility usage assistance device that generates a browsing screen to be displayed on the user terminal device; a display that displays the browsing screen; and a controller that controls the display. A time required for the user to use the usage area and congestion presentation information representing a congestion level of the usage area for each of a plurality of the usage areas where the use of the user is assumed are displayed on the browsing screen.

According to the present disclosure, since the required time and the congestion presentation information for each of the plurality of usage areas where the use of the user is assumed are displayed on the browsing screen, it is possible to allow a user to determine a destination as a usage area easily and quickly with intuitive determination.

### BRIEF DESCRIPTION OF DRAWINGS

FIG. 1 is a configuration diagram illustrating an entire facility usage assistance system according to of the present embodiment.

FIG. 2 is an exemplary diagram explaining a process of action when a user is using an airport.

FIG. 3 is a block diagram illustrating a hardware configuration of camera 1, server device 2, and user terminal device 3.

FIG. 4 is a functional block diagram of camera 1.

FIG. 5A is an exemplary image illustrating a privacy protected image generated by camera 1.

FIG. 5B is an exemplary image illustrating a privacy protected image generated by camera 1.

FIG. 6 is a functional block diagram of server device 2.

FIG. 7 is an exemplary diagram illustrating a display mode of a browsing screen displayed on user terminal device 3.

FIG. 8 is an exemplary diagram illustrating a setting screen displayed on user terminal device 3.

FIG. 9A is an exemplary diagram illustrating the browsing screen displayed on user terminal device 3.

FIG. 9B is an exemplary diagram illustrating the browsing screen displayed on user terminal device 3.

FIG. 10 is an exemplary diagram illustrating a process of action when a user is using a store in a facility usage assistance system according to a second embodiment.

FIG. 11A is an exemplary diagram illustrating a browsing screen displayed on user terminal device 3.

FIG. 11B is an exemplary diagram illustrating a browsing screen displayed on user terminal device 3.

FIG. 12 is an exemplary diagram illustrating a process of action when a user is using a store in a facility usage assistance system according to a third embodiment.

FIG. 13A is an exemplary diagram illustrating a browsing screen displayed on user terminal device 3.

FIG. 13B is an exemplary diagram illustrating a browsing screen displayed on user terminal device 3.

FIG. 14 is an exemplary diagram illustrating a browsing screen displayed on an information board according to a fourth embodiment.

FIG. 15 is an exemplary diagram illustrating a modification example of the browsing screen displayed on user terminal device 3.

### DESCRIPTION OF EMBODIMENTS

Prior to the description of the embodiments, problems of the related art will be briefly described. When a user is using a facility, there are cases that the user does not want to change the destination even if the store is crowded or the user wants to determine the destination after checking the state of a plurality of stores due to psychological factors such as high interest of the user. In such a case, it is desirable to provide information that allows the user to determine the destination easily and quickly with intuitive determination after presenting a state of the plurality of stores.

On the other hand, according to the related art disclosed in PTLs 1 and 2, it is possible to enhance user convenience by presenting a store to the user that matches current conditions and demands of the user based on information on congestion state (waiting time) and moving time in the store. However, according to both of these related arts, information narrowed down to the stores that the device determined to be desirable for the user is provided. As described above, there was no consideration about a request for information provision capable of allowing the user to determine the destination easily and quickly with intuitive determination.

An object of this disclosure is to provide a facility usage assistance method, a facility usage assistance device, and a user terminal device that allow a user to determine a destination easily and quickly with intuitive determination when the user is using the facilities.

In order to solve the above-described problem, according to a first disclosure, there is provided a facility usage assistance method that provides a user using a usage area with facility information on a congestion state of the usage area by an information processing device to assist a facility usage of the user. The facility usage assistance method, by the information processing device. includes acquiring congestion detection information for each usage area, detected from a captured image obtained by a camera capturing the image of the usage area; calculating a time required for the user to use the usage area for each usage area and acquiring congestion presentation information representing a congestion level of the usage area for each usage area, based on the congestion detection information; and generating a browsing screen including the required time and the congestion presentation information for each of a plurality of the usage areas where the use of the user is assumed.

According to the disclosure, since the required time and congestion presentation information for each of the plurality of usage areas where the use of the user is assumed are displayed on the browsing screen, it is possible to allow a user to determine a destination as a usage area easily and quickly with intuitive determination.

According to a second disclosure, the congestion presentation information may be character information representing the congestion level of the usage area with words.

According to the disclosure, it is possible to easily grasp the congestion state of the usage area.

According to a third disclosure, the congestion presentation information may be character information representing the congestion level of the usage area with the number of persons staying in the usage area.

According to the disclosure, it is possible to grasp the congestion state of the usage area in detail.

According to a fourth disclosure, the congestion presentation information may be a privacy protected image in which a person region in the captured image is changed to a mask image.

According to the disclosure, it is possible to easily grasp the actual congestion state of the usage area that is hard to grasp only with the character information. Moreover, since a privacy protected image is displayed, it is possible for unspecified number of users to browse the image.

According to a fifth disclosure, the method may further include by the information processing device, generating the browsing screen with a plurality of display modes selected according to an operation input of the user selecting the plurality of display modes having different congestion presentation information contents in the browsing screen.

According to the disclosure, since the user can select a preferred display mode among the plurality of display modes having different congestion presentation information contents, it is possible to enhance user convenience.

According to a sixth disclosure, the display modes may differ from one another in whether or not to display the privacy protected image in which the person region in the captured image is changed to the mask image as the congestion presentation information on the browsing screen.

According to the disclosure, since the user can select whether or not to display the privacy protected image, it is possible to enhance user convenience.

According to a seventh disclosure, there is provided a facility usage assistance device that provides a user using a usage area in a facility with information on a congestion state of the usage area by an information processing device to assist a facility usage of the user. The facility usage assistance device includes a communicator that performs communication with a camera that captures an image of the usage area and a user terminal device; and a controller that generates a browsing screen to be displayed on the user terminal device. The communicator receives congestion detection information for each usage area, detected from the image captured from the camera, and the controller calculates a time required for the user to use the usage area for each usage area and acquires congestion presentation information representing a congestion level of the usage area for each usage area, based on the congestion detection information, and generates a browsing screen including the required time and the congestion presentation information for each of a plurality of the usage areas where the use of the user is assumed.

According to the disclosure, similarly to the first disclosure, it is possible to allow a user to determine a destination easily and quickly with intuitive determination when the user is using a facility.

According to an eighth disclosure, there is provided a user terminal device that presents information on a congestion state of a usage area in a facility to a user using the usage area. The user terminal device includes a communicator that performs communication with a facility usage assistance device that generates a browsing screen to be displayed on the user terminal device; a display that displays the browsing screen; and a controller that controls the display. A time required for the user to use the usage area and congestion presentation information representing a congestion level of the usage area for each of a plurality of the usage areas where the use of the user is assumed are displayed on the browsing screen.

According to the disclosure, similarly to the first disclosure, it is possible to allow a user to determine a destination easily and quickly with intuitive determination when the user is using a facility.

Hereinafter, embodiments will be described with reference to the drawings.

### First Embodiment

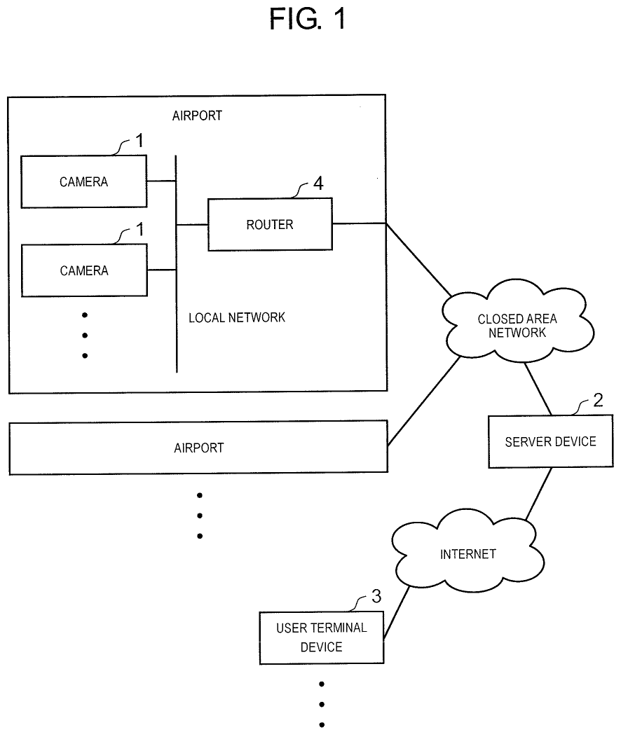

FIG. 1 is a configuration diagram illustrating an entire facility usage assistance system according to the present embodiment.

The facility usage assistance system is a system that provides a user using an airport (facility) with information on a congestion state of each usage area in the airport. The system includes camera 1, server device (facility usage assistance device) 2, and user terminal device 3.

Camera 1 is installed in a vicinity of each usage area such as a security inspection site in the airport, and captures an image of users staying in each usage area. Camera 1 is connected to server device 2 via a closed area network such as a local network, router 4, and a virtual local area network (VLAN).

Server device 2 receives a camera image transmitted from camera 1 install in the airport. Server device 2 is connected to user terminal device 3 via Internet. Server device 2 generates a screen to be browsed by the user, distributes the screen to the user, and acquires information that the user input on the screen of user terminal device 3.

User terminal device 3 is configured with a smart phone, tablet terminal, or PC. In user terminal device 3, a browsing screen transmitted from server device 2 is displayed. It is possible to grasp the congestion state of each usage area in the airport by the user browsing the browsing screen.

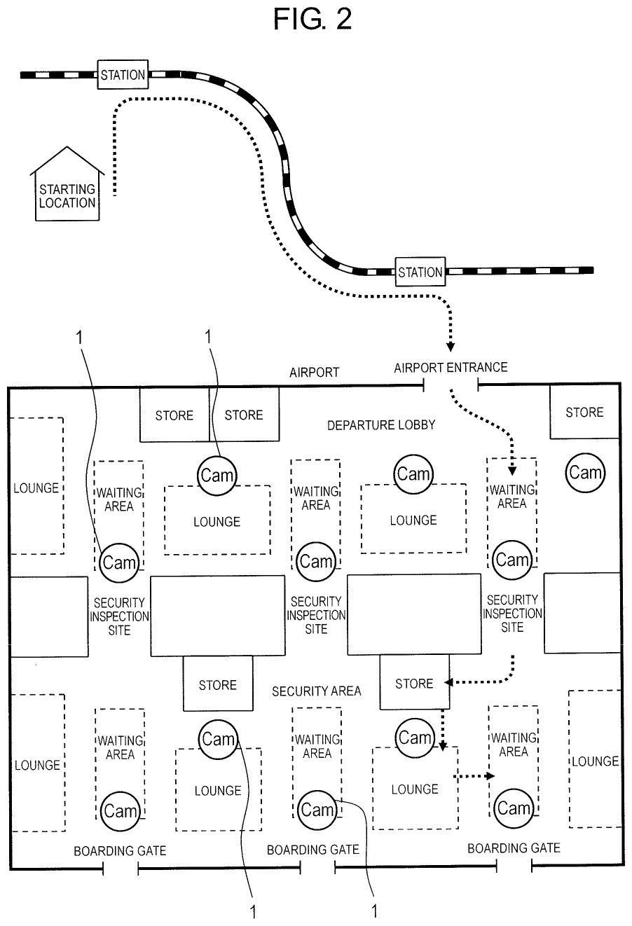

Next, a process of action when a user is using an airport will be explained. FIG. 2 is an exemplary diagram explaining the process of action when a user is using an airport. Hereinafter, a case where a user boards on a plane at an airport will be described.

In an airport, a departure lobby, a security inspection site, a security area, and a boarding gate are provided. In the departure lobby and the security area, a lounge and a store are provided.

In the departure lobby, camera 1 for capturing an image of users staying in the lounge or the store is installed. Camera 1 for capturing an image of users staying in a waiting area on an entrance side of the security inspection site is provided. In the security area, camera 1 for capturing an image of persons staying in the lounge or the store is installed. Camera 1 for capturing an image of users staying in a waiting area of a boarding gate is provided.

Camera 1 is an omnidirectional camera that has a 360-degree capturing range using a fisheye lens. It is possible to adopt a so-called box camera having a predetermined angle of view in camera 1.

A user heads to an airport using appropriate moving means (such as railroad, automobile) from a starting location (home, or work place, for example). When the user arrives at the airport, the user enters a departure lobby from an entrance, stays in a lounge of the departure lobby if necessary, and stops by a store. Next, the user enters a security inspection site. At this time, in a case where users waiting for entering the security inspection site are forming a line in a waiting area on the entrance side of the security inspection site, the user stands in the line. Next, when the user completes the security inspection at the security inspection site, the user enters a security area, stays in the lounge in the security area if necessary, and stops by a store. When a boarding announcement starts, the user boards on a plane through a boarding gate.

Here, when departing from a starting location, on the way to the airport, or staying at the departure lobby of the airport, the user has a desire to check the congestion state of a security inspection site, a lounge and a store in a security area, and the vicinity of the boarding gate to which the user heads. In a case where the user is staying in a store in the security area, the user has a desire to check the congestion state of a lounge in the security area, and the vicinity of the boarding gate to which the user heads.

In the present embodiment, based on a camera image captured users staying in a waiting area of the security inspection site, a lounge or a store in the security area, and a waiting area of the boarding gate, information on the congestion state of the security inspection site, the lounge and the store in the security area, and the boarding gate can be generated and presented to a user using user terminal device 3.

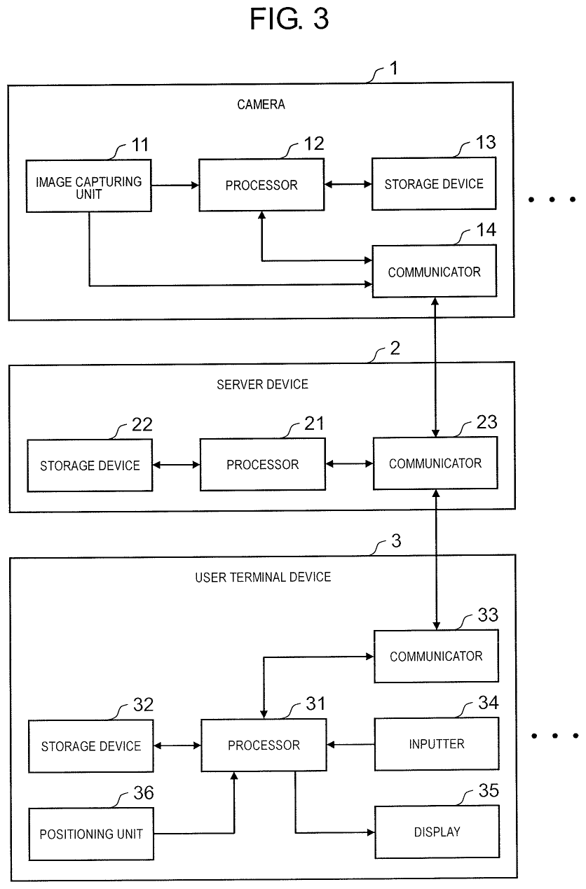

Next, schematic configurations of camera 1, server device 2, and user terminal device 3 will be explained. FIG. 3 is a block diagram illustrating a hardware configuration of camera 1, server device 2, and user terminal device 3.

Camera 1 includes image capturing unit 11, processor (controller) 12, storage device 13, and communicator 14.

Image capturing unit 11 includes an image sensor, and sequentially outputs temporally continuous captured images (frames), so-called a motion picture. Processor 12 performs a process of acquiring the number of people staying in each usage area (congestion detection information) based on the captured image output from image capturing unit 11. Moreover, processor 12 performs image processing on the captured image to protect the privacy of a person and generates a privacy protected image. Storage device 13 stores a program executed by processor 12, a captured image output from image capturing unit 11, and the like. Communicator 14 is to perform communication with the server device 2, and transmits the congestion detection information and the privacy protected image output from processor 12 to server device 2.

Server device 2 includes processor (controller) 21, storage device 22, and communicator 23.

Communicator 23 is to perform communication with camera 1 and user terminal device 3. Communicator 23 receives the congestion detection information and the privacy protected image transmitted from camera 1 and position information transmitted from user terminal device 3, and distributes a browsing screen to be browsed by the user to user terminal device 3. Storage device 22 stores the congestion detection information and the privacy protected image for each camera 1 received by communicator 23, a program executed by processor 21, and the like. Processor 21 generates the browsing screen to be distributed to user terminal device 3.

User terminal device 3 includes processor (controller) 31, storage device 32, communicator 33, inputter 34, display 35, and positioning unit 36.

The user inputs various set information into inputter 34. Display 35 displays a screen based on the screen information transmitted from server device 2. Inputter 34 and display 35 can be constituted with a touch panel display. Positioning unit 36 acquires position information of own device from a satellite positioning system such as a global positioning system (GPS). Communicator 33 performs communication with server device 2. Communicator 33 transmits the position information acquired by positioning unit 36 and the user set information input by inputter 34 to server device 2, and receives the screen information transmitted from server device 2. Processor 31 controls each portion of user terminal device 3. Storage device 32 stores the program executed by processor 31 and the like.

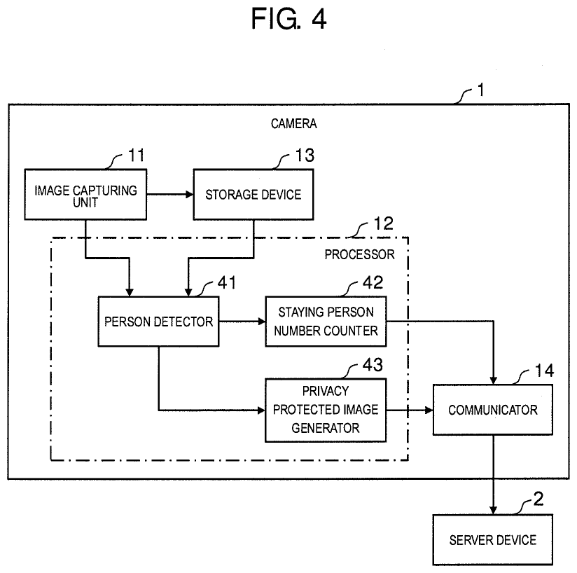

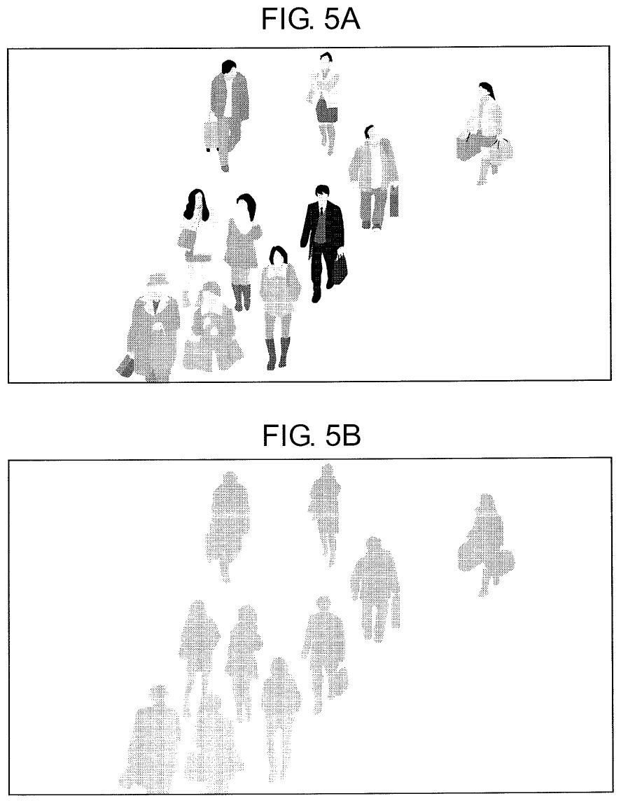

Next, a functional configuration of camera 1 will be explained. FIG. 4 is a functional block diagram of camera 1. FIGS. 5A and 5B are exemplary images illustrating a captured image and a privacy protected image generated by camera 1. FIG. 5A illustrates a captured image output from an image capturing unit, and FIG. 5B illustrates a privacy protected image that image processing to protect the privacy of a person is applied on the captured image.

Camera 1 includes person detector 41, staying person number counter 42, and privacy protected image generator 43. Person detector 41, staying person number counter 42, and privacy protected image generator 43 are realized by causing processor 12 to execute the program (instruction) stored in storage device 13.

Person detector 41 detects persons staying in the captured image by performing moving object detection and person detection on the captured image output from image capturing unit 11. Moreover, position information of an image region of persons staying in the captured image is acquired based on the detection results of moving object detection and person detection.

Specifically, first, a background image that removed moving objects from the captured image is generated based on a plurality of captured images (frames) in a predetermined learning period. Next, an image region of the moving object is specified (moving object detection) from the difference between a currently captured image and the background image acquired in the previous learning period. When a person face or an Q shape consisting of a head and shoulders is detected in the image region of the moving object, the moving object is determined as a person (person detection). A known technology may be used for the moving object detection and the person detection.

Staying person number counter 42 counts number of persons staying in each usage area as congestion detection information on a congestion state of each usage area based on the detection result of person detector 41. In the present embodiment, the number of persons staying in each waiting area of the security inspection site, lounge and store in the security area, and waiting area of the boarding gate is counted. The number of staying persons (congestion detection information) acquired from staying person number counter 42 is sent to server device 2 from communicator 14.

To count the number of staying persons in each usage area, a counting area corresponding to an image area that a usage area (waiting area of security inspection site, lounge and store in security area, and waiting area of boarding gate) is captured may be set on the captured image, and the number of persons staying in the counting area may be counted. If the capturing area of camera 1 corresponds to the usage area, persons in the entire captured image may be counted as a target.

Privacy protected image generator 43 generates the person region in the captured image (refer to FIG. 5A) output from image capturing unit 11 as a privacy protected image (refer to FIG. 5B) in which a person region is changed to a mask image based on a detection result of person detector 41. The privacy protected image acquired from privacy protected image generator 4 is transmitted to server device 2 from communicator 14.

To generate a privacy protected image, first, a mask image having an outline corresponding to the image region of a person is generated based on the position information of the image region of a person acquired by person detector 41. Then, a privacy protected image is generated by overlapping the mask image on the background image that removed moving objects from the captured image. The mask image is an image in which an inside of the outline of the person is filled with a predetermined color (blue, for example). The mask image has permeability so that the background of the image in the mask image is seen through in the privacy protected image.

The privacy protected image may be generated by performing image processing (such as mosaic processing, blurring processing, blending processing) that decreases identification of a person captured in the captured image on the entire captured image or the image region of a face. In addition, the privacy protected image may be generated by decreasing the image resolution to the extent that the identification of person is lost instead of performing the special image processing.

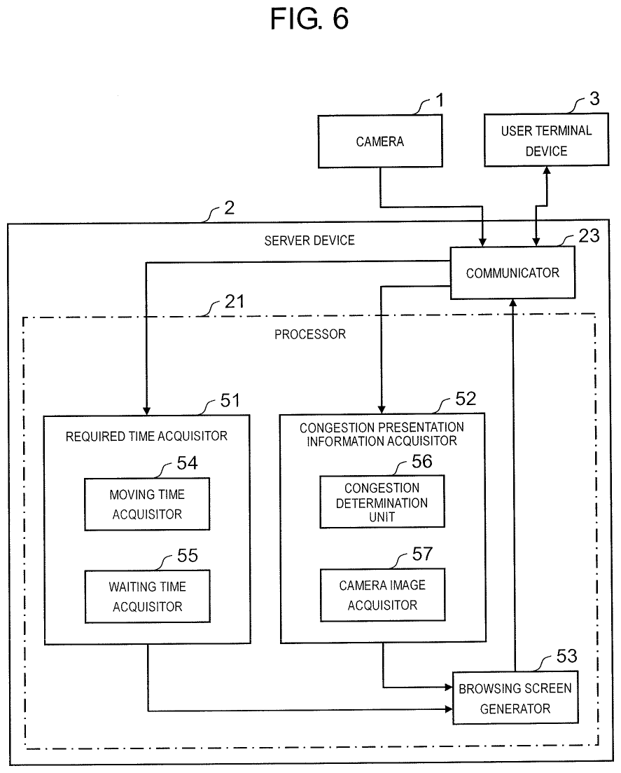

Next, a functional configuration of server device 2 will be explained. FIG. 6 is a functional block diagram of server device 2.

Server device 2 includes required time acquisitor 51, congestion presentation information acquisitor 52, and browsing screen generator 53. Required time acquisitor 51, congestion presentation information acquisitor 52, and browsing screen generator 53 are realized by causing processor 21 to execute the program (instruction) stored in storage device 22.

Required time acquisitor 51 calculates the time required for a user to move from a current location to a destination usage area and to start usage action in the usage area. The required time includes a moving time required for a user to move from the current location to the destination usage area and a waiting time required for the user from the time arrived at the destination usage area to start the usage action. Required time acquisitor 51 includes moving time acquisitor 54 and waiting time acquisitor 55.

Moving time acquisitor 54 acquires the moving time required for the user to move from the current location to the destination usage area based on the position information of the user transmitted from user terminal device 3 and received by communicator 23. At this time, route search for searching the optimal route from the current location to the destination usage area is performed. In a case where the user is staying outside the airport, route search of outside the airport targeting transportation such as a railroad and roads and route search of inside the airport are performed, and in a case where the user is staying inside the airport, route search of inside the airport is performed. The route search of outside the airport may be performed by a server device dedicated to a route search service.

Waiting time acquisitor 55 acquires a waiting time required for a user from the time arrived at the destination usage area to start the usage action based on the congestion detection information (number of staying people) for each usage area transmitted from camera 1 and received by communicator 23. In the present embodiment, the waiting time of the security inspection site is acquired. At this time, the waiting time of the security inspection site may be calculated from the number of persons staying in the waiting area of the security inspection site and an average time required for security inspection of a single person.

Congestion presentation information acquisitor 52 acquires congestion presentation information for presenting a user a congestion state of a usage area. Congestion presentation information acquisitor 52 includes congestion determination unit 56 and camera image acquisitor 57.

Congestion determination unit 56 compares the number of staying persons in the usage area with a predetermined threshold value to determine whether the usage area is congested or not. In the present embodiment, the number of persons staying in each of the lounge and the store in the security area, and the waiting area of the boarding gate is compared with a predetermined threshold value, and whether each of the lounge and the store in the security area, and the waiting area of the boarding gate is congested or not will be determined.

Camera image acquisitor 57 acquires a privacy protected image transmitted from camera 1 and received by communicator 23.

Browsing screen generator 53 generates a browsing screen based on the required time acquired in required time acquisitor 51, the privacy protected image and the congestion determination result acquired by congestion presentation information acquisitor 52, and the user set information transmitted from user terminal device 3 and received by communicator 23. In the present embodiment, as user set information, the information on a display mode that the user selected is transmitted from user terminal device 3, and browsing screen generator 53 generates a browsing screen according to the display mode selected by the user. Screen information on the browsing screen generated by browsing screen generator 53 is transmitted from communicator 23 to user terminal device 3 and is displayed on the browsing screen in user terminal device 3.

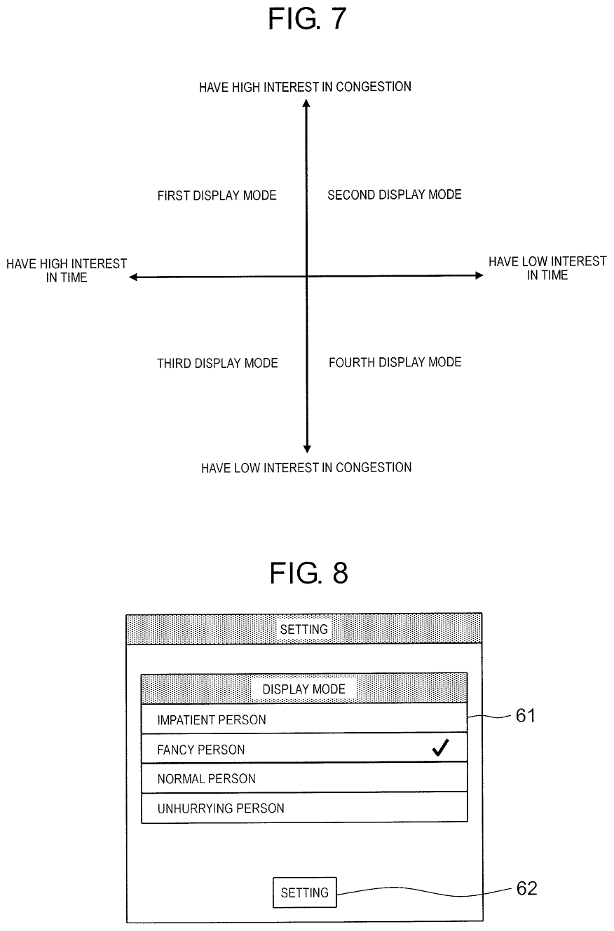

Next, the display mode of the browsing screen displayed on user terminal device 3 will be explained. FIG. 7 is an exemplary diagram illustrating the display mode of the browsing screen displayed on user terminal device 3.

In the present embodiment, first to fourth display modes are prepared depending on the degree of interest with respect to time and congestion on the browsing screen displayed on user terminal device 3, and the user can select a preferred display mode from these four display modes.

The first display mode is a mode set assuming a person who has high interest in time and high interest in congestion (impatient person). In this case, the user tends to select the usage area based on the fact that the required time is short, the usage area where the required time is the shortest is presented with priority. Since the user wants to know the actual state of the usage area, the user sets a camera image (privacy protected image) to be displayed. Moreover, since the user concerns about changes in the congestion state, the user sets the automatic update interval of the browsing screen to a short period (1 minute, for example).

The second display mode is a mode set assuming a person who has low interest in time and high interest in congestion (fancy person). In this case, since the user shows interest in the usage area where many people gather and are busy, a congested usage area is presented with priority. Since the user shows high interest in a highly entertaining usage area, a highly entertaining usage area (store, for example) and a usage area near the usage area (lounge, for example) are presented with priority. Moreover, since the user wants to know the actual state of the usage area, the user sets a camera image to be displayed. Since the user concerns about changes in the congestion state, the user sets the automatic update interval of the browsing screen to a short period (1 minute, for example).

The third display mode is a mode set assuming a person who has high interest in time and low interest in congestion (normal person). In this case, the user tends to select the usage area based on the fact that the required time is short, the usage area where the required time is the shortest is presented with priority. Since the user does not show interest in the actual state of the usage area, the user sets the camera image not to be displayed. Moreover, since the user does not concern about changes in the congestion state, the user sets the automatic update interval of the browsing screen to a long period (15 minutes, for example).

The fourth display mode is a mode set assuming a person who has low interest in time and low interest in congestion (unhurrying person). In this case, since the user shows high interest in a highly entertaining usage area, a highly entertaining usage area (store, for example) and a usage area near the usage area (lounge, for example) are presented with priority. Since the user does not show interest in the actual state of the usage area, the user sets the camera image not to be displayed. Moreover, since the user does not concern about changes in the congestion state, the user sets the automatic update interval of the browsing screen to a long period (15 minutes, for example).

Next, a setting screen displayed on user terminal device 3 will be explained. FIG. 8 is an exemplary diagram illustrating the setting screen displayed on user terminal device 3.

The setting screen is provided with display mode selector 61 and setting button 62. A preferred display mode can be selected among the first to fourth display modes in display mode selector 61, and a check mark that shows selected state is displayed on display mode selector 61 when an operation of selecting any one of the display modes is performed.

When a display mode is selected by display mode selector 61 and setting button 62 is operated, information on the user selected display mode is transmitted to server device 2 as user set information.

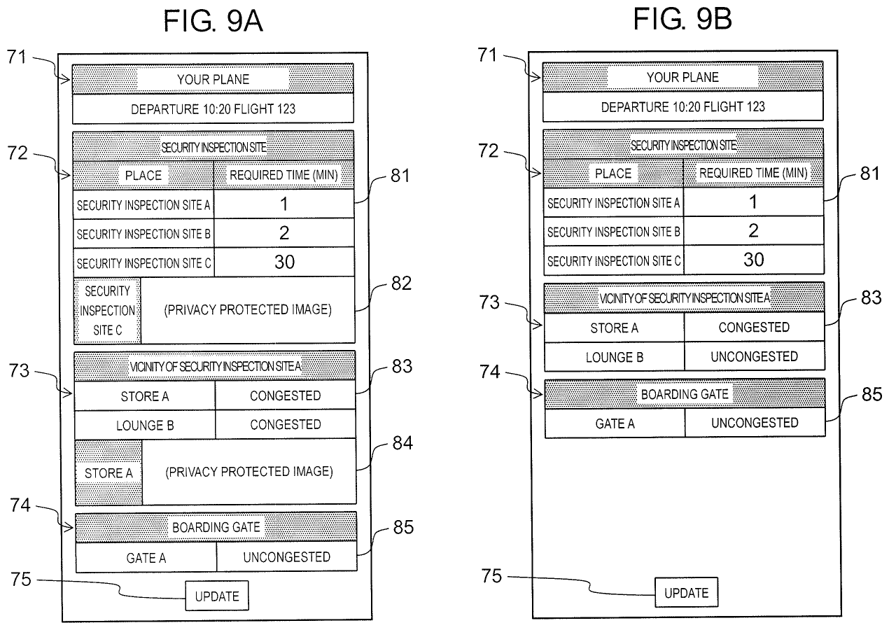

Next, the browsing screen displayed on user terminal device 3 will be explained. FIGS. 9A and 9B are exemplary diagrams illustrating the browsing screen displayed on user terminal device 3. FIG. 9A illustrates the browsing screen in case of the first and second display modes and FIG. 9B illustrates the browsing screen in case of the third and fourth display modes.

When the first display mode or the second display mode is selected on the setting screen illustrated in FIG. 8, the browsing screen illustrated in FIG. 9A is displayed on user terminal device 3. When the third display mode or the fourth display mode is selected on the setting screen illustrated in FIG. 8, the browsing screen illustrated in FIG. 9B is displayed on user terminal device 3.

As illustrated in FIG. 9A, the browsing screen of the first and second display modes is provided with flight information display 71, first, second, and third congestion state displays 72, 73, and 74, and update button 75.

Flight information display 71 displays information (departure time, flight number) on the plane the user is going to board.

First congestion state display 72 displays information on the congestion state of the security inspection site. First congestion state display 72 is provided with character information display 81 and camera image display 82. Character information display 81 displays a required time of each security inspection site. The required time is a sum of moving time of the user moved from the current location to each security inspection site and waiting time of the user in each security inspection site. Camera image display 82 displays a privacy protected image captured a waiting area of the security inspection site.

Moreover, character information display 81 may display only the waiting time not including the moving time as a required time. Character information display 81 may display character information that represent the congestion level with words such as “congested” or “uncongested” depending on the presence or absence of congestion.

Here, in the present embodiment, a privacy protected image to be displayed on camera image display 82 is determined based on the required time, and a privacy protected image of the security inspection site with the shortest required time is displayed on camera image display 82. The selected privacy protected image of the security inspection site selected may be displayed on camera image display 82 according to an operation of the user selecting the security inspection site in character information display 81.

Second congestion state display 73 displays information on the congestion state of a store and a lounge in the security area. Second congestion state display 73 is provided with character information display 83 and camera image display 84. Character information display 83 displays words “congested” or “uncongested” depending on whether it is congested or not. Camera image display 84 displays the privacy protected image captured the store or the lounge.

Here, in the present embodiment, information on the congestion state of the store and the lounge narrowed down to the store and the lounge near the security inspection site having the shortest required time is displayed on character information display 83. The privacy protected images of the store are displayed with priority on camera image display 84. The selected privacy protected image of the store and the lounge may be displayed on camera image display 82 according to an operation the user selecting the store or the lounge in character information display 83.

Third congestion state display 74 displays information on the congestion state of a waiting area of the boarding gate for the user to board on the using plane. Third congestion state display 74 is provided with character information display 85. Character information display 85 displays words “congested” or “uncongested” depending on whether it is congested or not.

Update button 75 is for the user to manually update the browsing screen.

In the present embodiment, the browsing screen is automatically updated at a predetermined automatic update interval. When updating the browsing screen, the character information (required time and presence or absence of congestion) and the privacy protected image may be updated at the same timing, that is, the character information and the privacy protected image at the same time may be acquired and displayed. At the time of congestion or when the congestion tends to increase, since the user interest is high, it is better to shorten the automatic update interval. In this case, the character information and the privacy protected image may be updated at a different timing to shorten the communication time.

The browsing screen displays the congestion state of each usage area in order according to the traveling direction of the user. Specifically, between the time a user enters the departure lobby and the time the user passes through the final destination, the boarding gate, the user sequentially passes the security inspection site, the store and the lounge in the security area, and the vicinity of the boarding gate, and the congestion state of each usage area is displayed in order according to the traveling direction of the user.

As illustrated in FIG. 9B, the browsing screen of the third and fourth display modes is provided with flight information display 71, first, second, and third congestion state displays 72, 73, and 74, and update button 75 similarly to the browsing screen of the first and second display modes illustrated in FIG. 9A. However, in the browsing screen of the third and fourth display modes, camera image displays 82 and 84 are omitted, and only character information displays 81 and 83 are provided in first and second congestion state displays 72 and 73. Accordingly, it is possible to simplify the browsing screen and make the character information easier to see.

The browsing screen displays information on the congestion state of each usage area as described above, but the information required by the user differs according to the current location of the user. Thereby, the display contents of the browsing screen may be changed depending on the current location of the user. That is, the congestion state of the usage area where the use of the user is not assumed from the current location of the user is unnecessary, and only the congestion state of the usage area where the use of the user is assumed from the current location of the user is displayed on the browsing screen.

Specifically, in a case where the user is staying outside the airport, that is, a starting location (home or work place), on the way, or staying in the departure lobby of the airport, the user concerns the congestion state of the usage area that the user is heading, that is, a security inspection site, a store and a lounge in the security area, and the vicinity of a boarding gate. As illustrated in FIGS. 9A and 9B, the congestion state of the security inspection site, a store and a lounge in the security area, and the vicinity of the boarding gate may be displayed. On the other hand, in a case where the user is staying in the waiting area of the security inspection site, since the congestion state of the security inspection site is unnecessary, the congestion state of a store and a lounge in the security area, and the vicinity of the boarding gate may be displayed. In a case where the user is staying in a store in the security area, the congestion state of a lounge in the security area, and the vicinity of the boarding gate may be displayed.

Character information display 81 of first congestion state display 72 displays the required time for each security inspection site, but the sorting order of the security inspection sites may be changed according to the display mode. Specifically, in the first display mode (impatient person) or the third display mode (normal person), since the user selects the security inspection site based on the required time, the security inspection sites are displayed in the order of the shortest required time. In the second display mode (fancy person) and the fourth display mode (unhurrying person), since the user shows high interest in a highly entertaining usage area, the security inspection sites may be displayed in the order of closest to the stores that are a highly entertaining usage area.

In the present embodiment, a browsing screen is selected by a user and the display contents of the browsing screen are changed according to the display mode, specifically, the presence or absence of the display of a camera image (privacy protected image) is switched. As a state where the camera image is displayed in the initial setting, the display of the camera image may be invalid according to the operation of the user.

### Second Embodiment

Next, a second embodiment will be explained. The points not particularly mentioned here are the same as those in the above embodiment.

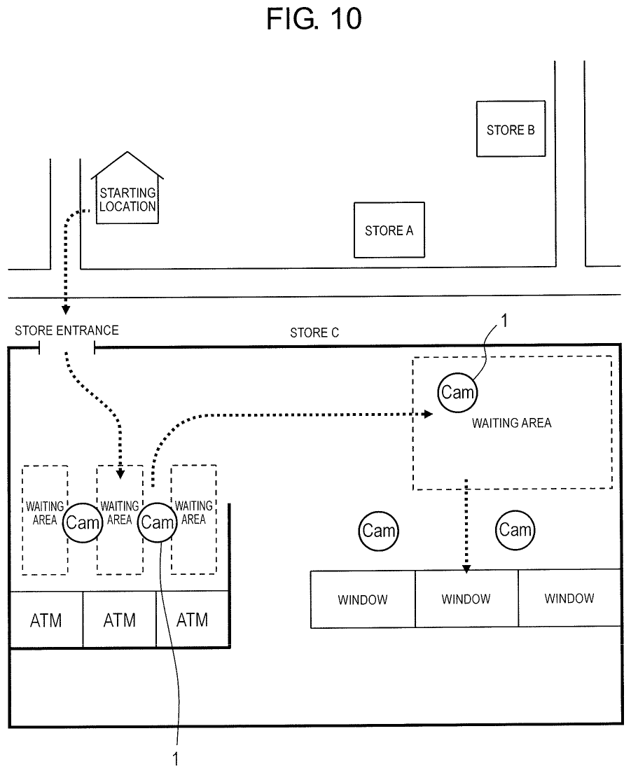

FIG. 10 is an exemplary diagram illustrating a process of action when a user is using a store in a facility usage assistance system according to a second embodiment.

The second embodiment is about a facility usage assistance system for banks. In a store (facility) of a bank, an automatic teller machine (ATM), an ATM waiting area, a window, and a window waiting area are provided. In the store, camera 1 for capturing an image of a user staying in the ATM waiting area and the window waiting area is provided.

A user walks or uses appropriate moving means (such as railroad, automobile) to go to the store from a starting location (home or work place, for example). When the user arrives at the bank, the user enters the store from an entrance, uses the ATM if necessary, and performs various procedures at the window. At this time, in a case where there is a prior customer at the ATM, the user needs to stand in a line formed in the ATM waiting area, and in a case where there is a prior customer at the window, the user needs to wait for a call at the window waiting area.

Here, first, the user decides which store to use as departing from the starting location, and there is a desire to check the congestion state of each of the plurality of stores. Even on the way to the store, there is a case that the user checks the congestion state of each of the plurality of stores and changes the store to use. Moreover, there is a case that the user moves to another store when the user arrives at the store and looking at the actual congestion state of the store.

In the present embodiment, information on the congestion state of ATMs and windows in each store is generated based on the camera image captured the users staying in the ATM waiting area and the window waiting area of each store, and is presented to the user using user terminal device 3.

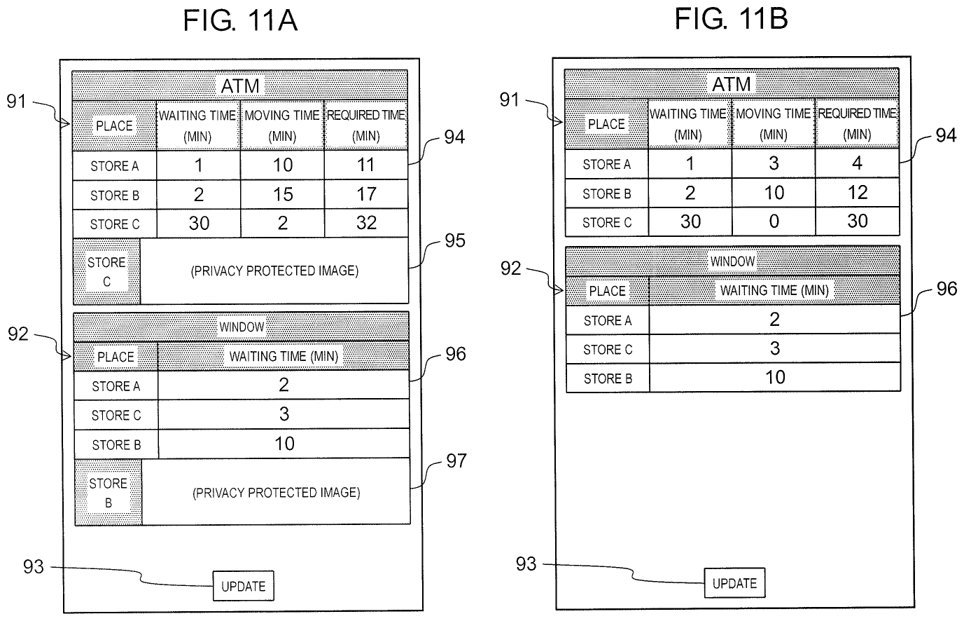

Next, a browsing screen displayed on user terminal device 3 will be explained. FIGS. 11A and 11B are exemplary diagrams illustrating a browsing screen displayed on user terminal device 3. The browsing screen in the case of the first and second display modes is displayed in FIG. 11A and the browsing screen in the case of the third and fourth display modes is displayed in FIG. 11B.

As illustrated in FIG. 11A, the browsing screen of the first and second display modes is provided with first and second congestion state displays 91 and 92, and update button 93.

First congestion state display 91 displays information on the congestion state of the ATM for each store. First congestion state display 91 is provided with character information display 94 and camera image display 95. Character information display 94 displays a waiting time, a moving time and a required time obtained by adding the waiting time and the moving time of an ATM for each store. Camera image display 95 displays a privacy protected image captured the ATM waiting area.

Here, in the example illustrated in FIG. 11A, a privacy protected image of store C with the longest waiting time is displayed on camera image display 95. A privacy protected image of a store selected by a user may be displayed according to an operation of the user selecting a store in character information display 94.

Second congestion state display 92 displays information on the congestion state of the window for each store. Second congestion state display 92 is provided with character information display 96 and camera image display 97. Character information display 96 displays the window waiting time of each store. Camera image display 97 displays a privacy protected image captured the waiting area.

Here, in an example illustrated in FIG. 11A, a privacy protected image of store B with longest waiting time is displayed on camera image display 97. A privacy protected image of a store selected by a user may be displayed according to an operation of the user selecting a store in character information display 96.

As illustrated in FIG. 11B, the browsing screen of the third and fourth display modes is provided with first and second congestion state displays 91 and 92 and update button 93, similarly to the browsing screen of the first and second display modes illustrated in FIG. 11A. However, in the browsing screen of the third and fourth display modes, camera image displays 95 and 97 are omitted, and only character information displays 94 and 96 are provided in first and second congestion state displays 91 and 92. Accordingly, it is possible to simplify the browsing screen and make the character information easier to see.

An example in FIG. 11B illustrates a case of browsing in the state of visiting store C, and the waiting time is 0 (min). Comparing the required time with other stores A and B, a user may move to other stores A and B.

### Third Embodiment

Next, a third embodiment will be explained. The points not particularly mentioned here are the same as those in the above embodiments.

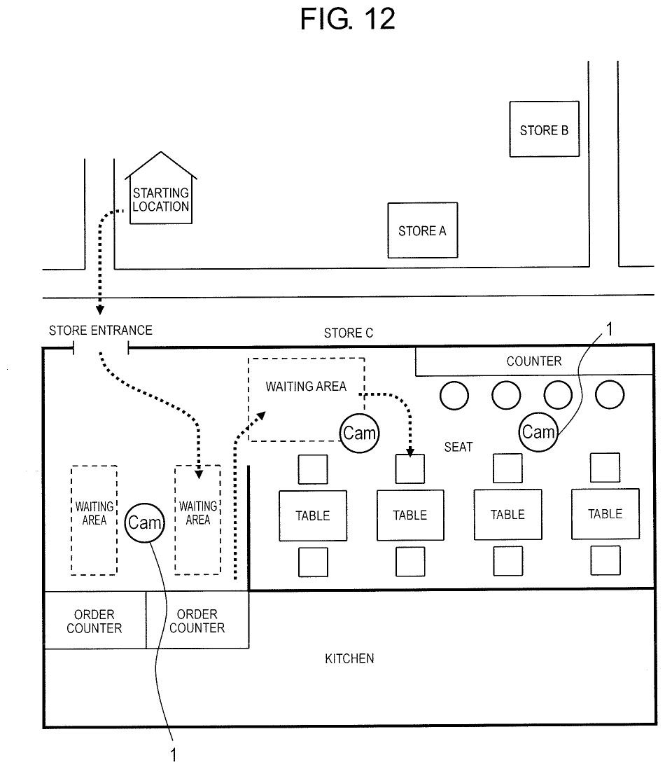

FIG. 12 is an exemplary diagram illustrating a process of action when a user is using a store in a facility usage assistance system according to the third embodiment.

The third embodiment is about a facility usage assistance system for a quick service restaurant such as a fast food store. In a store of the quick service restaurant (facility), an order counter, an order counter waiting area, seats, and a seat waiting area are provided. In the store, camera 1 for capturing users staying in the order counter waiting area and the window waiting area is installed.

A user walks or uses appropriate moving means (such as railroad, automobile) to go to the store from a starting location (home or work place, for example). When the user arrives at the store, the user enters the store from an entrance, orders at the order counter, receives food, and eats the food at the seat or leaves the store in case of take-out. At this time, in a case where there is a prior customer at the order counter, the user needs to stand in a line formed in the order counter waiting area, and in a case where the seats are full, the user needs to wait for a seat at the seat waiting area.

Here, first, the user decides which store to use as departing from the starting location, and there is a desire to check the congestion state of each of the plurality of stores. Even on the way to the store, there is a case that the user checks the congestion state of each of the plurality of stores and changes the store to use. Moreover, there is a case that the user moves to another store when the user arrives at the store and looking at the actual congestion state of the store.

In the present embodiment, information on the congestion state of the order counter and seats in each store is generated based on the camera image captured the users staying in the order counter waiting area and the seat waiting area of each store, and is presented to the user using user terminal device 3.

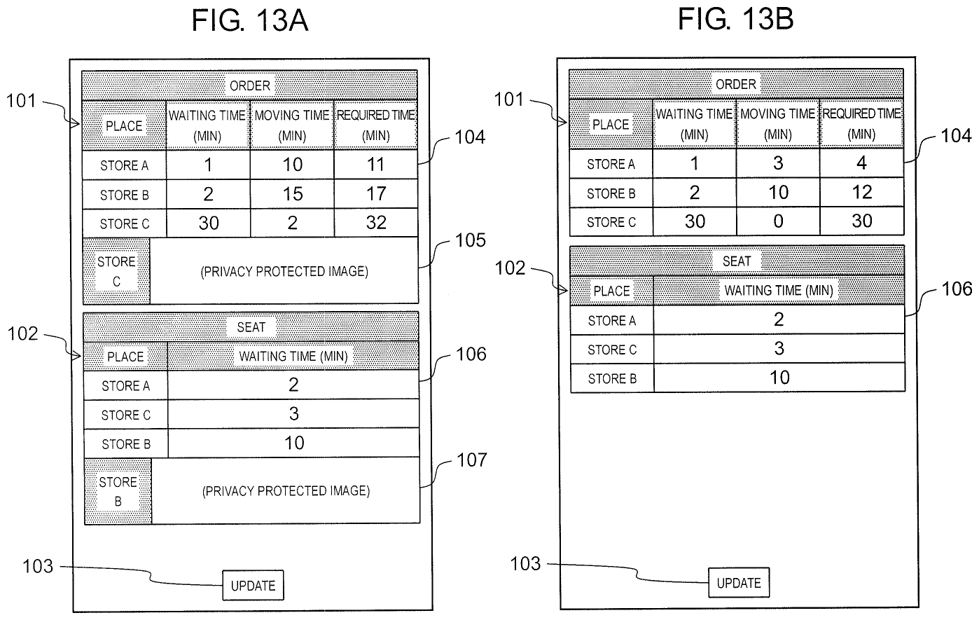

Next, the browsing screen displayed on user terminal device 3 will be explained. FIGS. 13A and 13B are exemplary diagrams illustrating a browsing screen displayed on user terminal device 3. The browsing screen in the case of the first and second display modes is displayed in FIG. 13A and the browsing screen in the case of the third and fourth display modes is displayed in FIG. 13B.

As illustrated in FIG. 13A, the browsing screen of the first and second display modes is provided with first and second congestion state displays 101 and 102, and update button 103.

First congestion state display 101 displays information on the congestion state of an order counter for each store. First congestion state display 101 is provided with character information display 104 and camera image display 105. Character information display 104 displays a waiting time, a moving time and a required time obtained by adding the waiting time and the moving time of an order counter for each store. Camera image display 105 displays a privacy protected image captured the order counter waiting area. Here, in the example illustrated in FIG. 13A, a privacy protected image of a store with the longest waiting time is displayed on camera image displays 105 and 107. A privacy protected image of a store selected by a user may be displayed according to an operation of the user selecting a store in character information displays 104 and 106.

Second congestion state display 102 displays information on the congestion state of seats for each store. Second congestion state display 102 is provided with character information display 106 and camera image display 107. Character information display 106 displays the seat waiting time of each store. Camera image display 107 displays a privacy protected image captured the seat waiting area.

As illustrated in FIG. 13B, the browsing screen of the third and fourth display modes is provided with first and second congestion state displays 101 and 102 and update button 103, similarly to the browsing screen of the first and second display modes illustrated in FIG. 13A. However, in the browsing screen of the third and fourth display modes, camera image displays 105 and 107 are omitted, and only character information displays 104 and 106 are provided in first and second congestion state displays 101 and 102. Accordingly, it is possible to simplify the browsing screen and make the character information easier to see.

### Fourth Embodiment

Next, a fourth embodiment will be explained. The points not particularly mentioned here are the same as those in the above embodiments.

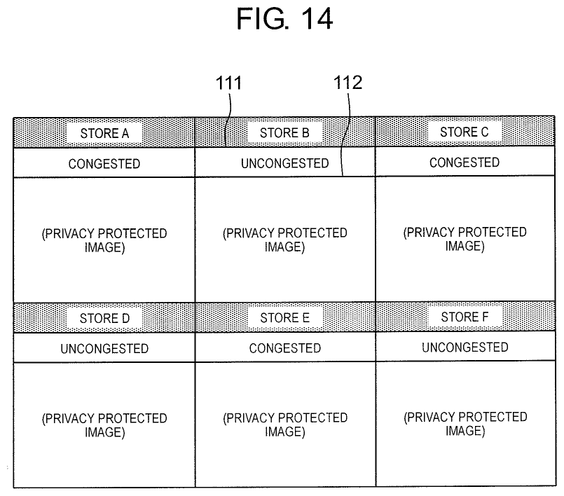

FIG. 14 is an exemplary diagram illustrating a browsing screen displayed on an information board according to the fourth embodiment.

In a large-scale commercial facility such as a shopping center, an information board (guide plate device, user terminal device) is installed at an information counter (information center) and the like. On the information board, the browsing screen illustrated in FIG. 14 is displayed to present a user a congestion state of each usage area in the facility.

Camera 1 is installed in each usage area of the facility. Server device 2 is installed in a management office in the facility and the like. Server device 2 collects congestion detection information and privacy protected images from each camera 1 to generate a browsing screen, and the browsing screen is displayed on the information board.

The browsing screen displays information on the congestion state of each usage area in the facility. The example illustrated in FIG. 14 illustrates a case where a facility includes a plurality of stores, and information on the congestion state of each store is displayed. The browsing screen is provided with character information display 111 and camera image display 112 for each usage area. Character information display 111 displays words “congested” or “uncongested” depending on whether it is congested or not. Camera image display 112 displays a privacy protected image captured stores.

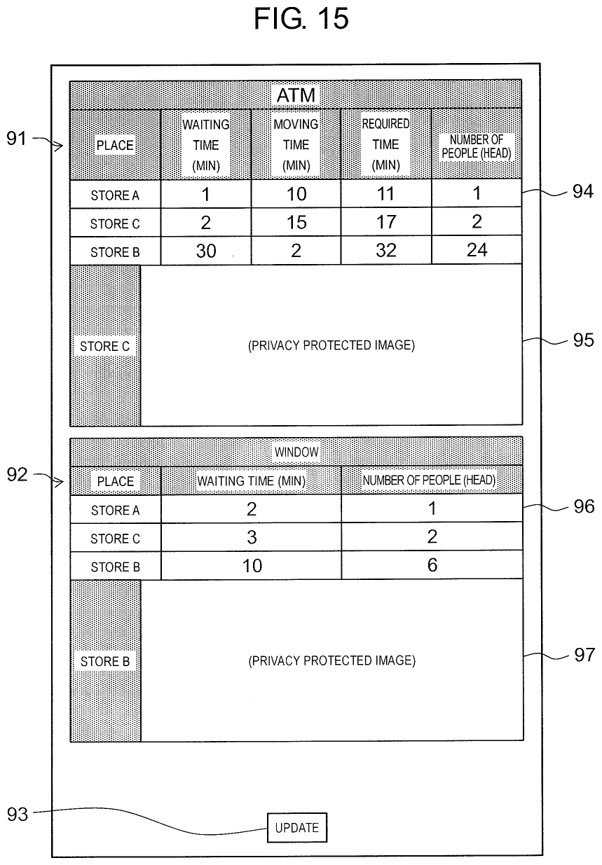

Next, a modification example of a browsing screen displayed on user terminal device 3 will be explained. FIG. 15 is an exemplary diagram illustrating the modification example of the browsing screen displayed on user terminal device 3.

The browsing screen displays information on the congestion state of an ATM and a window in a store of a bank to a user similarly in the second embodiment. However, it is different from the example illustrated in FIGS. 11A and 11B, and displays the number of waiting people for ATMs and windows, that is, the number of persons staying in the ATM waiting area and the window waiting area on character information displays 94 and 96. Accordingly, it is possible to grasp the congestion state of the ATM and the window in detail.

As described above, as an example of the technology disclosed in the present application, embodiments are described. However, the technology in the disclosure is not limited to this, and can also be applied to embodiments in which change, substitution, addition, omission, and the like are made. Further, it is also possible to combine each constituent element described in the above-described embodiments to form a new embodiment.

For example, in the first to third embodiments, as a target facility for displaying a congestion state on a user terminal device, examples of an airport, a bank, and a quick service restaurant are explained. However, the target facility is not limited to this, and can be widely applied to service areas, resort facilities, leisure facilities such as theme parks, and commercial facilities such as shopping centers.

In the above-described embodiments, in the camera, congestion detection information (number of staying people) of a usage area is acquired from an image captured the usage area, and the congestion detection information is transmitted to a server device. However, a process for acquiring the congestion detection information may be performed by a server device.

In the above-described embodiments, in the camera, the number of people in a usage area is counted and the number of people in the usage area is transmitted to a server device as congestion detection information, and the congestion detection information is acquired from the number of people in the usage area in the service device. However, heat map information representing the person distribution state in the image captured by a camera may be transmitted to a server device as congestion detection information.

The heat map information is information that counts the number of persons present in each cell (grid) obtained by dividing a captured image into a grid and represents a person distribution state with the count value (number of people) in each cell. By transmitting the heat map information from a camera to a server device, the waiting time and the congestion presentation information (such as presence or absence of congestion, number of waiting people) can be acquired in the service device.

### INDUSTRIAL APPLICABILITY

The facility usage assistance method, the facility usage assistance device and the user terminal device according to the disclosure have effect of allowing a user to determine a destination as a usage area easily and quickly with intuitive determination when the user uses a facility, and are useful as a facility usage assistance method, a facility usage assistance device, and a user terminal device for assisting the facility usage of the user by providing information on a congestion state of a usage area to a facility user with an information processing device.

### REFERENCE MARKS IN THE DRAWINGS

1 CAMERA
2 SERVER DEVICE
3 USER TERMINAL DEVICE
12 PROCESSOR (CONTROLLER)
14 COMMUNICATOR
21 PROCESSOR (CONTROLLER)
23 COMMUNICATOR
31 PROCESSOR (CONTROLLER)
33 COMMUNICATOR
34 INPUTTER
35 DISPLAY
36 POSITIONING UNIT
41 PERSON DETECTOR
42 STAYING PERSON NUMBER COUNTER
43 PRIVACY PROTECTED IMAGE GENERATOR
51 REQUIRED TIME ACQUISITOR
52 CONGESTION PRESENTATION INFORMATION ACQUISITOR
53 BROWSING SCREEN GENERATOR
54 MOVING TIME ACQUISITOR
55 TIME ACQUISITOR
56 CONGESTION DETERMINATION UNIT
57 CAMERA IMAGE ACQUISITOR

1. A facility usage assistance method that provides a user using a usage area in a facility with information on a congestion state of the usage area by an information processing device to assist a facility usage of the user, the method comprising:
by the information processing device,
acquiring congestion detection information for each usage area, detected from a captured image obtained by a camera capturing the image of the usage area;
calculating a time required for the user to use the usage area for each usage area and acquiring congestion presentation information representing a congestion level of the usage area for each usage area, based on the congestion detection information; and
generating a browsing screen including the required time and the congestion presentation information for each of a plurality of the usage areas where the use of the user is assumed.

2. The facility usage assistance method of claim 1,
wherein the congestion presentation information is character information representing the congestion level of the usage area with words.

3. The facility usage assistance method of claim 1,
wherein the congestion presentation information is character information representing the congestion level of the usage area with the number of persons staying in the usage area.

4. The facility usage assistance method of claim 1,
wherein the congestion presentation information is a privacy protected image in which a person region in the captured image is changed to a mask image.

5. The facility usage assistance method of claim 1, further comprising:
by the information processing device,
generating the browsing screen with a plurality of display modes selected according to an operation input of the user selecting the plurality of display modes having different congestion presentation information contents in the browsing screen.

6. The facility usage assistance method of claim 5,
wherein the plurality of display modes differ from one another in whether or not to display the privacy protected image in which the person region in the captured image is changed to the mask image as the congestion presentation information on the browsing screen.

7. A facility usage assistance device that provides a user using a usage area in a facility with information on a congestion state of the usage area by an information processing device to assist a facility usage of the user, comprising:
a communicator that performs communication with a camera that captures an image of the usage area and a user terminal device; and
a controller that generates a browsing screen to be displayed on the user terminal device,
wherein the communicator receives congestion detection information for each usage area, detected from the image captured from the camera, and
wherein the controller
calculates a time required for the user to use the usage area for each usage area and acquires congestion presentation information representing a congestion level of the usage area for each usage area, based on the congestion detection information, and
generates a browsing screen including the required time and the congestion presentation information for each of a plurality of the usage areas where the use of the user is assumed.

8. A user terminal device that presents information on a congestion state of a usage area in a facility to a user using the usage area, comprising:
a communicator that performs communication with a facility usage assistance device that generates a browsing screen to be displayed on the user terminal device;
a display that displays the browsing screen; and
a controller that controls the display,
wherein a time required for the user to use the usage area and congestion presentation information representing a congestion level of the usage area for each of a plurality of the usage areas where the use of the user is assumed are displayed on the browsing screen.
